(19) United States
(12) Patent Application Publication
(10) Pub. No.: US 2026/0116476 A1
(43) Pub. Date: Apr. 30, 2026

(54) WIND DEFLECTOR SYSTEM FOR A VEHICLE

(71) Applicant: International Truck Intellectual Property Company, LLC, Lisle, IL (US)

(72) Inventor: Glenn Scott Moeller, Chicago, IL (US)

(73) Assignee: International Truck Intellectual Property Company, LLC, Lisle, IL (US)

(21) Appl. No.: 18/930,289

(22) Filed: Oct. 29, 2024

(51) Int. Cl. B62D 35/00

(52) U.S. Cl. CPC B62D 35/001

(57) ABSTRACT

A vehicle includes a chassis, a cab supported by the chassis, the cab forming an enclosure with a top and a rear, and a movable wind deflector movably connected to the cab. The wind deflector is configured to move in between a top towing or hauling position, wherein the wind deflector is located at the top of the cab and extends above the top of the cab to redirect airflow over a payload when the vehicle is transporting the payload, and a rear deadheading or bobtailing position, wherein the wind deflector is located at the rear of the cab and extends rearwardly therefrom to prevent air from creating a low pressure area next to the rear of the cab when the vehicle is deadheading or bobtailing without the payload connected thereto.

### BACKGROUND

This disclosure relates to towing vehicles. Particularly, this disclosure relates to systems and methods for reducing wind drag on a towing vehicle.

### RELATED ART

A towing vehicle, such as a semi-tractor, experiences wind drag when both towing a trailer (i.e., hauling or towing) and not towing the trailer (i.e., deadheading or bobtailing). This aerodynamic drag greatly reduces the fuel efficiency of the towing vehicle. When towing, one area where a significant amount of drag is generated is at a gap between the rear of the cab of the vehicle and the front of the trailer. When towing at speed, air becomes trapped in the gap between the cab and the trailer, which creates a low-pressure wake behind the cab that accordingly increases the drag acting on the cab. To combat wind drag during towing, it is known in the art to attach one or more wind deflectors onto the top and/or sides of the cab that extend rearwardly of the cab to decrease the size of the gap between the cab and the trailer. Also, the wind deflectors redirect the air so that the air flows over the gap in a more fluid (or less turbulent) manner, thus decreasing the pressure differential and effective wind drag on the vehicle.

Generally, wind deflectors are typically rigid components that are permanently and immovably affixed to the cab of the vehicle. Some prior art wind deflectors, such as spoilers or side air flaps, can be adjustable via servo motors to adjust the height (or distance) which they extend above (or beyond) the cab. For example, some side air flaps at the sides of the cab can be retracted when performing a turning maneuver so that the trailer does not damage or otherwise contact the side air flaps.

When deadheading, without towing a load, the cab of the vehicle can still experience a significant amount of wind drag as pooled air behind the cab creates a vacuum at the rear of the cab that effectively pulls the vehicle in the rearward direction. Additionally, if equipped, the wind deflectors on the cab of the vehicle increase the overall surface area of the cab of the vehicle upon which the wind acts against, thus increasing the overall wind drag experienced by the cab of the vehicle. No known prior art wind deflectors decrease the size of the vacuum created at the rear of the cab of the vehicle when deadheading.

### SUMMARY

According to one embodiment, a vehicle includes a chassis, a cab supported by the chassis, the cab forming an enclosure with a top and a rear, and a movable wind deflector movably connected to the cab. The wind deflector is configured to move in between a top hauling or towing position, wherein the wind deflector is located at the top of the cab and extends above the top of the cab to redirect airflow over a payload when the vehicle is transporting the payload, and a rear deadheading or bobtailing position, wherein the wind deflector is located at the rear of the cab and extends rearwardly therefrom to prevent air from creating a low pressure area next to the rear of the cab when the vehicle is deadheading or bobtailing without the payload connected thereto.

According to another embodiment, a wind deflector system for a cab of a vehicle includes a wind deflector. The wind deflector is configured to movably connect to the cab of the vehicle. The wind deflector is further configured to move in between a top hauling or towing position, wherein the wind deflector is located at a top of the cab and extends above the top of the cab to redirect airflow over a payload when the vehicle is transporting the payload, and a rear deadheading or bobtailing position, wherein the wind deflector is located at a rear of the cab and extends rearwardly therefrom to prevent air from creating a low pressure area at the rear of the cab when the vehicle is deadheading or bobtailing without the payload connected thereto.

According to yet another embodiment, a method for reducing wind resistance on a vehicle includes several steps. The method includes an initial step of providing a vehicle including a chassis, a cab supported by the chassis, the cab forming an enclosure with a top and a rear, and a movable wind deflector movably connected to the cab. The method further includes a step of moving the wind deflector into a top hauling or towing position, wherein the wind deflector is located at the top of the cab and extends above the top of the cab to redirect airflow over a payload when the vehicle is transporting the payload. The method further includes a step of moving the wind deflector into a rear deadheading or bobtailing position, wherein the wind deflector is located at the rear of the cab and extends rearwardly therefrom to prevent air from creating a low pressure area next to the rear of the cab when the vehicle is deadheading or bobtailing without the payload connected thereto.

### DESCRIPTION OF THE DRAWINGS

FIG. 1 is a graphical representation of a wind deflector system for a vehicle, which includes a movable wind deflector to reduce wind resistance when the vehicle is towing a load, such as a trailer (i.e., hauling or towing), or when the vehicle is not towing the load (i.e., deadheading or bobtailing), wherein the wind deflector is in a first, top position, resting on top of a cab of the vehicle to deflect the wind away from the towed trailer;

FIG. 2 is a graphical representation of the wind deflector system of FIG. 1, wherein the wind deflector is in a second, rear position, residing behind the cab of the vehicle when the vehicle is not towing the trailer;

FIG. 3 is a graphical representation of the wind deflector system of FIG. 1, illustrating a rear view of the cab of the vehicle, wherein the wind deflector is in its top position above the cab of the vehicle;

FIG. 4 is a graphical representation of the wind deflector system of FIG. 1, illustrating an exemplary travel path of the wind deflector between its top and rear positions, both of which being illustrated relative to the cab of the vehicle.

FIG. 5 is a graphical representation of another embodiment of a wind deflector system, wherein the wind deflector defines at least part of a sleeper unit, wherein the wind deflector is in its top position for hauling or towing; and

FIG. 6 is a graphical representation of the wind deflector system of FIG. 5, wherein the wind deflector is in its rear position for deadheading or bobtailing.

### DETAILED DESCRIPTION

Embodiments described herein relate to arrangements, and methods of implementing, of a wind deflector system for a vehicle to reduce wind drag during hauling or towing when towing a payload and also during deadheading or bobtailing without towing a payload. The apparatus and method may be applied to various types of vehicles, including passenger, recreational, and commercial vehicles, such as highway or semi-tractors, straight trucks, busses, fire trucks, motorhomes, and etcetera. It is contemplated that the apparatus and method may be applied to vehicles having drivetrains including a diesel, gasoline, or gaseous fuel engine, as well as to vehicles having hybrid electric drivetrains. It is further contemplated that the apparatus and method may be applied to vehicles having manual transmissions, automatic transmissions, automated manual transmissions, continuously variable transmissions, hybrid electric transmissions, and hydraulic transmissions, as non-limiting examples. It is further contemplated that the apparatus and method may be applied to autonomous or semi-autonomous vehicles. As used herein, the term towing or hauling can refer to an operational state of the vehicle, wherein the vehicle is towing a payload, such as a trailer, a tank trailer, a container, or other cargo. As used herein, the term deadheading or bobtailing can refer to an operational state of the vehicle, wherein the vehicle is not towing a payload.

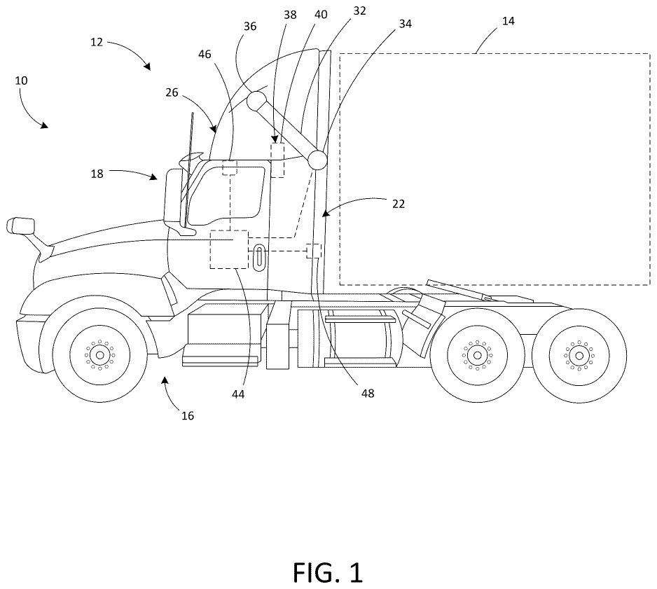

Turning now to FIGS. 1-4, a vehicle 10 implementing an embodiment of the present wind deflector system 12 is shown. The vehicle 10 can be in the form of a tow vehicle 10, such as a semi-tractor, for transporting a payload 14, such as a trailer 14 as shown in phantom in FIG. 1. For instance, the vehicle 10 can be a class 8 truck, capable of towing a trailer attached thereto.

The vehicle 10 generally includes a chassis 16, a cab 18 which forms an enclosure that houses the operator, and a prime mover (not shown). The cab 18 generally includes a top 20 and a bottom (unnumbered), a front (unnumbered) and a rear 22, and sides (unnumbered) extending therebetween which collectively form the enclosure. The top 20 and rear 22 of the cab 18 are connected to one another at a corner 24, at which the wind deflector system 12 may be movably mounted. Each side includes a door (unnumbered) therein, allowing the operator to enter and exit the cab 18.

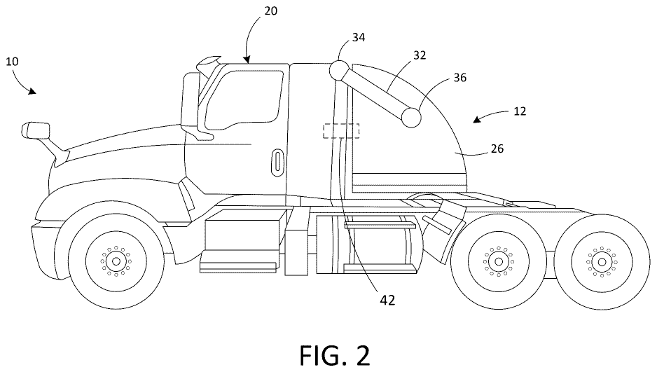

The wind deflector system 12 includes a wind deflector 26 movably connected to the cab 18 and selectively movable in between at least two operating positions, including a top hauling or towing position (or upper position) in which the vehicle 10 is towing a payload or hauling (FIG. 1) and a rear deadheading or bobtailing position (or bottom position) in which the vehicle 10 is traveling without a payload, deadheading, or bobtailing (FIG. 2). In the top hauling or towing position, as illustrated in FIG. 1, the wind deflector 26 rests against and extends above the top 20 of the cab 18 to redirect airflow over a payload, reducing the wind drag at a gap or area between the cab 18 and the front of the trailer 14. In the rear deadheading or bobtailing position, as illustrated in FIG. 2, the wind deflector 26 is located at the rear 22 of the cab 18 and extends rearwardly therefrom. Since the wind deflector 26 occupies the space next to the rear 22 of the cab 18 in the rear deadheading or bobtailing position, the wind deflector 26 prevents air from pooling behind the cab 18, which would otherwise create a low pressure area (or vacuum) next to the rear 22 of the cab 18 when traveling at speed. This low pressure area rearwardly of the cab 18 would otherwise serve to apply a rearward drag force in opposition to the forward direction of travel. Thus, the wind deflector 26, in the rear deadheading or bobtailing position, decreases drag by dually eliminating the rearward drag force from a low pressure area behind the cab 18 (directly next to the rear 22) and also increasing the amount of laminar airflow traveling around the top 20 and sides of the cab 18. Thereby, during both hauling and deadheading, the movable wind deflector 26 serves to augment fluid flow, decrease wind drag by eliminating low-pressure pocket(s) of air, and increase fuel efficiency. No known prior art wind deflectors, including extendable and retractable deflectors or spoilers, can eliminate, or even marginally reduce, the rearward drag force resulting from low-pressure pockets of air created next to the rear 22 of the cab 18 when deadheading or bobtailing.

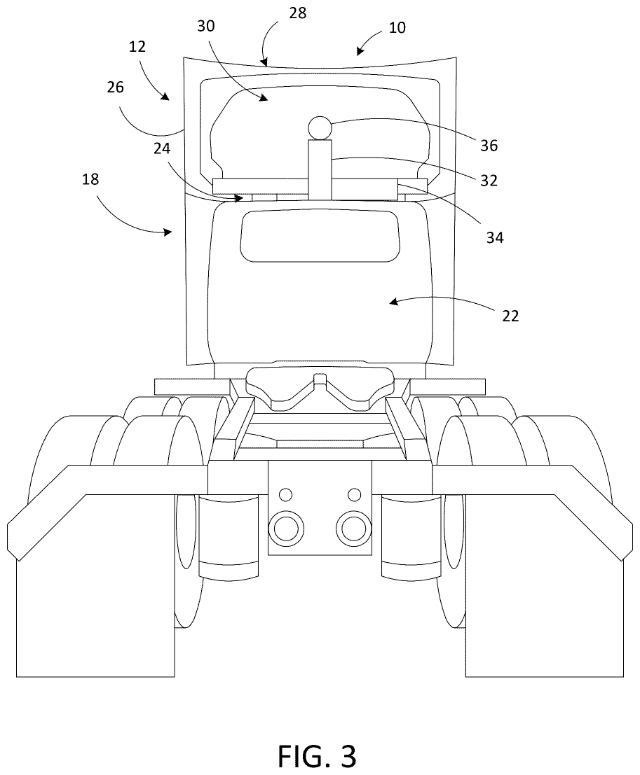

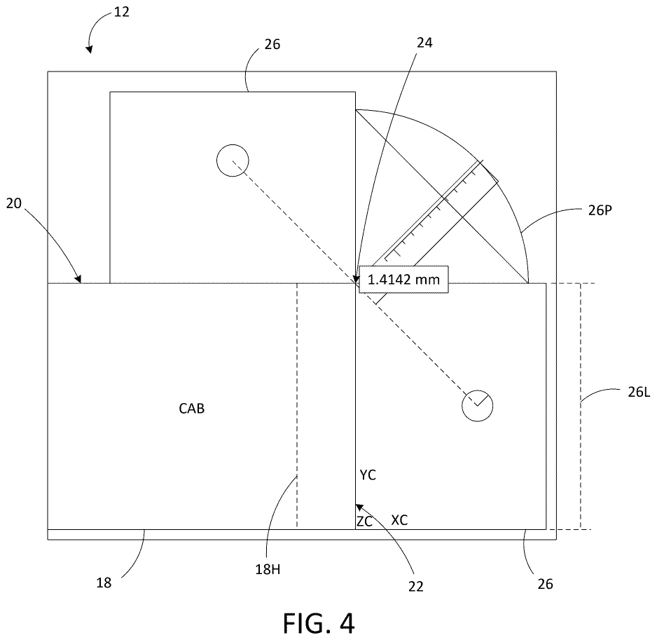

The wind deflector 26 can comprise any desired shape, size, and material. As shown in FIGS. 1-3, the wind deflector 26 comprises a monolithic shell body 28 with an outer, arcuate surface (unnumbered) and a corresponding inner surface 30 which defines an inner cavity that opens at its rear end (FIG. 3). As shown in FIG. 4, in one embodiment, the wind deflector 26 can comprise a length 26L that substantially matches a height 18H of the cab 18 (e.g., within a 5-30% margin of being identical) such that the wind deflector 26 substantially covers the rear 22 of the cab 18 in the rear deadheading or bobtailing position (e.g., within a 5-30% margin of completely covering the rear 22 of the cab 18). The wind deflector 26 can reside entirely above the rear 22 of the cab 18 in its top hauling or towing position and entirely beneath the top 20 of the cab 18 in its rear deadheading or bobtailing position. The wind deflector 26 can be automatically and/or manually movable in between its top hauling and rear deadheading positions.

The wind deflector system 12 can further include an arm 32 and a motor 34 connected thereto for automatically positioning the wind deflector 26 in its top hauling or towing position and rear deadheading or bobtailing position upon user input via corresponding controls (e.g., display screen, buttons, switches, etc.). The arm 32 rotatably connects the wind deflector 26 to the cab 18 so that the wind deflector 26 may rotate in between the top hauling or towing position and the rear deadheading or bobtailing position, without contacting the cab 18 during rotation thereof. In other words, the arm 32 (by nature of having a fixed length) sets a fixed arcuate travel path 26P of the wind deflector 26 (FIG. 4), allowing the wind deflector 26 to be freely rotated throughout its full range of motion without mechanical interference from the cab 18. The arm 32 includes a first end connected to the underside 30 of the wind deflector 26 via a mounting joint 36 and a second end, opposite the first end, rotatably connected to the cab 18 and/or the motor 34 via one or more fasteners (not shown).

In one embodiment, the arm 32 can be connected to the cab 18 at, e.g., directly onto or next to, the corner 24 of the cab 18 between the top 20 and rear 22 of the cab 18, allowing the arm 32 to freely pivot throughout its full range of motion without obstruction from the body of the cab 18. Hence, the length and the location of the mounting position of the arm 32 may both assist in allowing the wind deflector 26 to rotate freely without mechanically interfering with or otherwise contacting the cab 18. As shown in FIG. 4, the arm 32 may rotate approximately 180 degrees, plus or minus 10 degrees, throughout the travel path 26P, in between its maximum top and forwardly directed position (in the top hauling or towing position of the wind deflector 26) and its maximum rear and downwardly directed position (in the rear deadheading or bobtailing position of the wind deflector 26). In one embodiment, the length of the arm 32 can be approximately three-quarters of the height 26H of the wind deflector 26. The arm 32 can comprise any desired material, such as stainless steel or aluminum.

The mounting joint 36 connects the first end of the arm 32 to the wind deflector 26. The mounting joint 36 can be in the form of a pivot pin and corresponding receiving holes or a ball joint and socket. The fasteners, which connect the second end of the arm 32 to the cab 18 and/or the motor 34, can be in the form of screws, bolts, pins, etc.

The motor 34 is configured to automatically rotate the arm 32, and wind deflector 26 therewith, upon actuation by the operator. The motor 34 is connected to the cab 18 and the arm 32. In one embodiment, as shown in FIG. 3, the motor 34 can be connected at the corner 24 between the top 20 and rear 22 of the cab 18. The motor 34 can be any desired motor, such as an electric, hydraulic, or pneumatic motor.

In an alternative embodiment, the wind deflector system 12 may have a tracked system to effectuate movement of the wind deflector 26, in replacement of an arm 32 and a motor 34. Therein, the wind deflector system 12 may include rollers, tracks, and/or a belt, cable, and/or chain that allow the wind deflector 26 to slide relative to the cab 18. Additionally, the rollers, tracks, and/or belt may be driven by a respective motor. For example, the wind deflector 26 may be mounted on two or more rollers, at its front end, that fit within respective tracks at the sides of both the top 20 and rear 22 of the cab 18 (not shown).

The wind deflector system 12 may also include a locking mechanism 38 which can be automatically and/or manually toggled to unsecure and secure the wind deflector 26 relative to the cab 18 (as shown in phantom in FIG. 1). In other words, the locking mechanism 38 can selectively lock the wind deflector 26 onto the top or rear of the cab 18. The locking mechanism 38 can be automatically and/or manually manipulated.

The locking mechanism 38 can comprise any desired locking mechanism, such as one or more fasteners, bolts, latches, locking pins, bosses and detents, hook and loop fasteners, etc., for interlocking the wind deflector 26 to the cab 18. In one embodiment, the locking mechanism 38 may include a first set of locking features, such as a first latch 40, located at the top of the cab 18 for securing the wind deflector 26 in the top hauling or towing position and a second set of locking features, such as a second latch 42, located at the rear of the cab 18 for securing the wind deflector 26 in the rear deadheading or bobtailing position (as shown in phantom in FIGS. 1-2, respectively). In one embodiment, the wind deflector system 12 may not include a separate locking mechanism and as such the motor 34 may serve to lock or otherwise immobilize the wind deflector 26.

Furthermore, as shown in FIG. 1, the wind deflector system 12 can include a deflector controller 44, with a memory and one or more processors, that may or may not be integrated with a vehicle control unit (VCU). The wind deflector system 12 can further include one or more deflector sensors 46, 48 such as position, optical, or pressure sensors connected to the cab 18, motor 34, arm 32, and/or wind deflector 26, for sensing a position of the wind deflector 26, and/or one or more payload sensors (not shown) for detecting whether the vehicle 10 is hauling or deadheading. The deflector sensors 46, 48 can be operably connected to the controller 44. In one embodiment, the wind deflector system 12 can include a top position sensor 46 mounted at the top 20 of the cab 18 for sensing when the wind deflector 26 is on top of the cab 18 in its top towing or hauling position and a rear position sensor 48 mounted at the rear 22 of the cab 18 for sensing when the wind deflector 26 is at the rear 22 of the cab 18 in its rear deadheading or bobtailing position. The controller 44 can be operably connected to the VCU, one or more sensors, such as the deflector position sensors 46, 48, the motor 34, and the locking mechanism 38. In one embodiment, the controller 44 may automatically actuate the motor 34 to position the wind deflector 26, upon receiving a user input command and/or via autonomously sensing and determining an operational state of the vehicle 10, the presence of a trailer 14, and a position of the wind deflector 26.

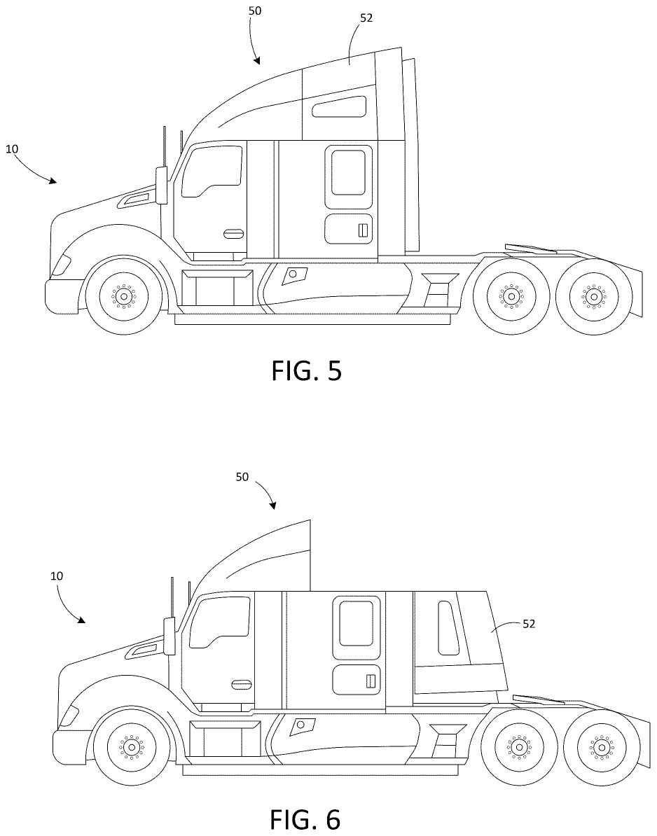

Turning now to FIGS. 5-6, another embodiment of a wind deflector system 50, with an enclosed wind deflector 52, is shown. The wind deflector 52 can be substantially similar to the wind deflector 26 as discussed above, except that the wind deflector 52 itself forms at least part of an enclosure, such as a sleeper unit. As shown in FIGS. 5-6, the wind deflector can comprise a multi-sectional body 54 that defines at least a portion of a sleeper unit. As used herein, the term sleeper unit, or sleeper, can refer to an enclosure within which the operator may sleep or otherwise use, such as for example as an additional storage area. The sleeper unit can include any desired furniture and amenities therein, such bunks, tables, chairs, lighting equipment, storage closets and other furniture and amenities.

In operation, the operator may manually or semi-automatically position the wind deflector 26, 52 in its top hauling or towing position or rear deadheading or bobtailing position. For instance, the operator may manually unlock the locking mechanism 38 and thereafter input a user command so that the motor 34 will automatically rotate the arm 32, and the wind deflector 26, 52 therewith, into the top hauling or towing position or the rear deadheading or bobtailing position. Once in position, the operator may relock the locking mechanism 38 to resecure the wind deflector relative to the cab 18. In an alternative embodiment, the vehicle 10 can be autonomous or semi-autonomous, and the controller 44 may automatically position and lock the wind deflector in its desired position depending upon whether the vehicle 10 will be hauling or deadheading.

While illustrative arrangements, and control logic therefor, implementing the wind deflector system have been described with respect to at least one embodiment, the arrangements and methods can be further modified within the spirit and scope of this disclosure, as demonstrated previously. This application is therefore intended to cover any variations, uses, or adaptations of the arrangement and method using its general principles. Further, this application is intended to cover such departures from the present disclosure as come within known or customary practice in the art to which the disclosure pertains and which fall within the limits of the appended claims.

What is claimed is:

1. A vehicle, comprising:
a chassis;
a cab supported by the chassis, the cab forming an enclosure with a top and a rear; and
a movable wind deflector movably connected to the cab, the wind deflector configured to move in between:
a top towing or hauling position wherein the wind deflector is located at the top of the cab and extends above the top of the cab to redirect airflow over a payload when the vehicle is transporting the payload; and
a rear deadheading or bobtailing position wherein the wind deflector is located at the rear of the cab and extends rearwardly therefrom to prevent air from creating a low pressure area next to the rear of the cab when the vehicle is deadheading or bobtailing without the payload connected thereto.

2. The vehicle of claim 1, further comprising:
an arm configured to rotatably connect the wind deflector to the cab, the arm comprising a first end connected to an underside of the wind deflector and a second end, opposite the first end, connected to the cab, the arm configured to rotate the wind deflector in between the top towing or hauling position and the rear deadheading or bobtailing position.

3. The vehicle of claim 2, further comprising:
a motor connected to the cab and the arm, the motor configured to automatically rotate the arm to thereby rotate the wind deflector in between the top towing or hauling position and the rear deadheading or bobtailing position.

4. The vehicle of claim 2, wherein:
the wind deflector is rigidly connected to an end of the arm via a mounting joint at the underside of the wind deflector.

5. The vehicle of claim 2, wherein:
the cab further comprises a corner that connects the top and rear of the cab together; and
the arm is rotatably connected to the cab at the corner such that that the wind deflector is free from mechanical interference from the cab when rotating the wind deflector in between the top towing or hauling position and the rear deadheading or bobtailing position.

6. The vehicle of claim 1, wherein:
the wind deflector comprises a shell body.

7. The vehicle of claim 1, wherein:
the wind deflector comprises at least a portion of a sleeper unit.

8. The vehicle of claim 1, wherein:
the wind deflector resides entirely above the rear of the cab in the top towing or hauling position; and
the wind deflector resides entirely beneath the top of the cab in the rear deadheading or bobtailing position.

9. The vehicle of claim 1, wherein:
the wind deflector comprises a length that substantially matches a height of the cab such that the wind deflector substantially covers the rear of the cab in the rear deadheading or bobtailing position.

10. The vehicle of claim 1, further comprising:
a locking mechanism configured to rigidly secure the wind deflector onto the cab in the top towing or hauling position and the rear deadheading or bobtailing position.

11. A wind deflector system for a cab of a vehicle, comprising:
a wind deflector configured to movably connect to the cab of the vehicle, the wind deflector further configured to move in between:
a top towing or hauling position wherein the wind deflector is located at a top of the cab and extends above the top of the cab to redirect airflow over a payload when the vehicle is transporting the payload; and
a rear deadheading or bobtailing position wherein the wind deflector is located at a rear of the cab and extends rearwardly therefrom to prevent air from creating a low pressure area at the rear of the cab when the vehicle is deadheading or bobtailing without the payload connected thereto.

12. The wind deflector system of claim 11, further comprising:
an arm configured to rotatably connect the wind deflector to the cab, the arm comprising a first end connected to an underside of the wind deflector and a second end, opposite the first end, configured to rotatably connect to the cab, and the arm configured to rotate the wind deflector in between the top towing or hauling position and the rear deadheading or bobtailing position.

13. The wind deflector system of claim 12, further comprising:
a motor configured to connect to the cab and the arm, the motor configured to automatically rotate the arm to thereby rotate the wind deflector in between the top towing or hauling position and the rear deadheading or bobtailing position.

14. The wind deflector system of claim 12, wherein:
the wind deflector is rigidly connected to an end of the arm via a mounting joint at the underside of the wind deflector.

15. The wind deflector system of claim 12, wherein:
the arm is configured to rotatably connect to the cab at a corner thereof, in between the top and the rear of the cab, such that that the wind deflector is free from mechanical interference from the cab when rotating the wind deflector in between the top towing or hauling position and the rear deadheading or bobtailing position.

16. The wind deflector system of claim 11, wherein:
the wind deflector comprises a shell body.

17. The wind deflector system of claim 11, wherein:
the wind deflector comprises at least a portion of a sleeper unit.

18. The wind deflector system of claim 11, wherein:
the wind deflector resides entirely above the rear of the cab in the top towing or hauling position; and
the wind deflector resides entirely beneath the top of the cab in the rear deadheading or bobtailing position.

19. The wind deflector system of claim 11, further comprising:
a locking mechanism configured to rigidly secure the wind deflector onto the cab in the top towing or hauling position and the rear deadheading or bobtailing position.

20. A method, comprising:
providing vehicle including a chassis, a cab supported by the chassis, the cab forming an enclosure with a top and a rear, and a movable wind deflector movably connected to the cab;
moving the wind deflector into a top towing or hauling position wherein the wind deflector is located at the top of the cab and extends above the top of the cab to redirect airflow over a payload when the vehicle is transporting the payload; and
moving the wind deflector into a rear deadheading or bobtailing position wherein the wind deflector is located at the rear of the cab and extends rearwardly therefrom to prevent air from creating a low pressure area next to the rear of the cab when the vehicle is deadheading or bobtailing without the payload connected thereto.
